(19) United States
(12) Patent Application Publication
(10) Pub. No.: US 2007/0022836 A1
(43) Pub. Date: Feb. 1, 2007

(54) Geared motor and shaft member for geared motor

(75) Inventors: Takao Shigemi, Kurashiki-shi (JP); Masanori Egawa, Chiryu-shi (JP); Tetsushi Isozaki, Kurashiki-shi (JP)

Correspondence Address: SQUIRE, SANDERS & DEMPSEY L.L.P., 14TH FLOOR, 8000 TOWERS CRESCENT, TYSONS CORNER, VA, 22182, US

(73) Assignee: SUMITOMO HEAVY INDUSTRIES, LTD.

(21) Appl. No.: 11/452,251

(22) Filed: Jun. 14, 2006

(30) Foreign Application Priority Data
Jun. 16, 2005 (JP) 2005-176296

(51) Int. Cl. H02K 7/116

(52) U.S. Cl. 74/421 A

(57) ABSTRACT

A motor with a helical pinion is made available as the motor for a hypoid geared motor. The hypoid geared motor includes a motor with a helical pinion formed on a motor shaft; a shaft member having an engagement portion integrally rotatable with the helical pinion at one end and having a hypoid pinion formed at the other end; and a hypoid gear to engage with the hypoid pinion.

### BACKGROUND OF THE INVENTION

1. Field of the Invention

The present invention relates to geared motors, and more particularly to a geared motor using a motor having a helical pinion, and to a shaft member suitable for use in the geared motor.

2. Description of the Related Art

A hypoid gear set including a hypoid pinion and a hypoid gear is capable of converting the axis of rotation to an axis at a right angle, and thus known as a so-called orthogonal conversion mechanism. The orthogonal conversion mechanism made up of the hypoid gear set allows for reducing the assembly in size, providing a higher efficiency than a worm gear set having the same functionality, operating with lower noise and less vibration than a bevel gear set, and ensuring a high reduction ratio through one stage. For this reason, there are strong needs in a specific field for a drive apparatus that incorporates the orthogonal conversion mechanism made up of the hypoid gear set. For instance, its example is a so-called “hypoid geared motor” in which a gearbox accommodating the orthogonal conversion mechanism made up of the hypoid gear set and a motor are assembled into one piece to provide power in harmony with optimum torque and rotational speed (e.g., see Japanese Patent Laid-Open Publication No. 2001-74110).

From a cost-wise viewpoint, on a quantity basis, a majority of gearboxes used as a geared motor employ a parallel axis gear mechanism. For this reason, to cope with this situation, a large number of motors with a pinion that have been ever shipped are configured such that the motor shaft is provided in advance with a spur pinion (spur gear) or a helical pinion (helical gear), allowing the motor shaft to serve also as an input shaft at the first stage of a reducer.

On the other hand, in a recent factory, to realize the production of various kinds of products in small batches, “alterations” are frequently made such that production and transfer facilities within the factory are recombined or changed to provide more suitable torque or transfer speeds. Accordingly, for example, it is not a rare case where a machine which has ever used a parallel axis gear mechanism is demanded to convert the axis of rotation of its output shaft to an axis at a right angle.

To address such a demand, an arrangement is disclosed in Japanese Patent Laid-Open Publication No. 1998-299840, in which to make use of an existing motor with a pinion, the rotation from the motor is once received by a gear (intermediate stage) that engages with the pinion formed on the motor shaft, and then the power is transmitted to the originally intended hypoid pinion.

For example, from the viewpoint of an entire transfer system, a “geared motor” is regarded as one of its components. It has been considered to be one of great advantages that the component can be replaced to change the specification of the entire transfer system. In this sense, it can be said that the geared motor has been considered to be “the smallest unit part” in the system.

The geared motor is largely divided into a parallel axis family and an orthogonal axis family. Conventionally, in this background, the fact is that the families were almost completely separated from each other. For example, a motor with a helical pinion of the parallel axis family formed at an end of the motor shaft was separated from a motor with a hypoid pinion of the orthogonal axis family in any aspects of design, manufacture, and sale.

Utilizing the technique described in Japanese Patent Laid-Open Publication No. 1998-299840 would surely enable “diversified use of the motor” itself. However, the technique is adapted such that the rotation of the motor is received once by a gear (intermediate stage) engaging with the pinion formed on the motor shaft and thereafter the power is transmitted to the originally intended hypoid pinion. Therefore, the hypoid gear set cannot be used at “the first stage,” thus possibly causing an increase in size of the hypoid gear set and a significant increase in costs. On the other hand, when the intermediate stage is used as an idle stage with no reduction at the intermediate stage to avoid these situations, the involvement of the intermediate stage would totally cause not only an increase in costs but also degradation in space efficiency.

### SUMMARY OF THE INVENTION

The present invention has focused attention on potential problems in view of the aforementioned background to address those problems by employing inventive ideas. It is therefore an object of the present invention to enable a motor with a helical pinion, which is originally intended for use in combination with a parallel axis gearbox, to be used as the motor of a geared motor having a hypoid gear set.

It is another object of the invention to provide a shaft member for a geared motor to obtain a reasonable structure for coupling a helical pinion to a hypoid pinion.

The present invention has achieved the aforementioned objects by providing a motor having a helical pinion formed on a motor shaft; a shaft member having, at one end, an engagement portion engaging with the helical pinion and integrally rotatable with the helical pinion, and having a hypoid pinion formed at the other end; and a hypoid gear to engage with the hypoid pinion.

According to the present invention, prepared is the shaft member which has, at one end, the engagement portion engaging with the helical pinion of the motor shaft and integrally rotatable with the helical pinion, and which also has the hypoid pinion formed at the other end. With this arrangement, the helical pinion and the shaft member are engaged with each other at the engagement portion on the one side, while the hypoid pinion engages with the hypoid gear on the other side, thereby forming the reduction mechanism of a reduction portion.

This makes it possible to form an orthogonal geared motor in which, while a helical pinion motor of the parallel axis family is being used, reduced output of the motor shaft is produced on an output shaft that is orthogonal to the motor shaft. Additionally, since the hypoid pinion can be separated from the “motor” side, changes to design such as changes in reduction ratio can be readily made.

The present invention further provides an advantage that a higher-cost hypoid gear set can be used at “the first stage” of small torque when compared with a structure in which the helical pinion of the motor shaft is received, e.g., by a traditional parallel axis gear mechanism, and the hypoid gear set is coupled as the subsequent stage.

Furthermore, according to the present invention, the motor shaft having a “helical pinion” formed thereon can be combined with a reduction portion employing a hypoid gear set, thereby rationally handling the thrust force produced on the hypoid gear set and the thrust force produced on the helical pinion side according to applications or purposes of service. As a result, it is possible to further provide reductions in noise, size, and/or costs, as discussed later.

In this regard, the shaft member may be supported by a pair of bearings, and positioned in both axial directions via the pair of bearings. This arrangement would make it possible to achieve rotatable smooth support of the shaft member and arbitrary handling of thrust force in a reasonable manner.

The shaft member may also be configured to have a projected portion on a periphery thereof, so that the shaft member can be positioned in both axial directions via the projected portion. This arrangement also makes it possible to achieve rotatable smooth support of the shaft member and arbitrary handling of the thrust force in a reasonable manner.

Note that the present invention can also be seen from the viewpoint of the shaft member for a geared motor that transmits the rotation of a motor shaft having a helical pinion at an end towards a reduction portion.

According to the present invention, a large number of motors with a helical pinion, which are used in existing factories or the like (or found in the market of geared motors), can be utilized as the motor of an orthogonal geared motor without any changes made thereto. Thus, while nothing is wasted, it is possible to provide a useful geared motor with a high degree of flexibility in design.

Furthermore, a large number of motors with a helical pinion of the parallel axis family, which is abundant in stock, can be used as an orthogonal family motor, thus allowing the hypoid pinion to be available on the “shaft member” side separated from the motor. It is possible for makers to readily organize product lines of a hypoid geared motor which have a high degree of flexibility in changing reduction ratios and which cover a large number of reduction ratios.

### BRIEF DESCRIPTION OF THE DRAWINGS

FIG. 1 is a cross-sectional front view illustrating a hypoid geared motor according to an exemplary embodiment of the present invention;

FIG. 2 is a developed cross-sectional plan view illustrating the hypoid geared motor;

FIG. 3 is a cross-sectional front view illustrating a hypoid geared motor according to another exemplary embodiment of the present invention;

FIG. 4 is a developed cross-sectional plan view illustrating the hypoid geared motor;

FIG. 5 is a front view of a plate for the hypoid geared motor;

FIG. 6 is a cross-sectional front view, corresponding to FIG. 1, illustrating a modified example of the exemplary embodiment of FIG. 1;

FIG. 7 is a developed cross-sectional plan view, corresponding to FIG. 2, illustrating the modified example;

FIG. 8 is a cross-sectional front view, corresponding to FIG. 3, illustrating a modified example of the exemplary embodiment of FIG. 3; and

FIG. 9 is a developed sectional plan view, corresponding to FIG. 4, illustrating the modified example.

### DETAILED DESCRIPTION OF THE PREFERRED EMBODIMENTS

Now, an explanation will be given to the exemplary embodiments of the present invention with reference to the drawings.

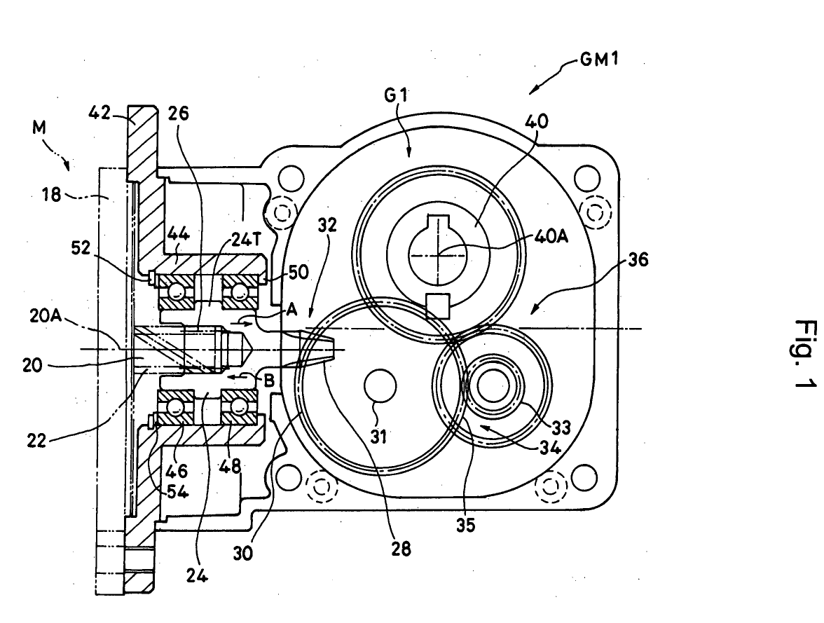

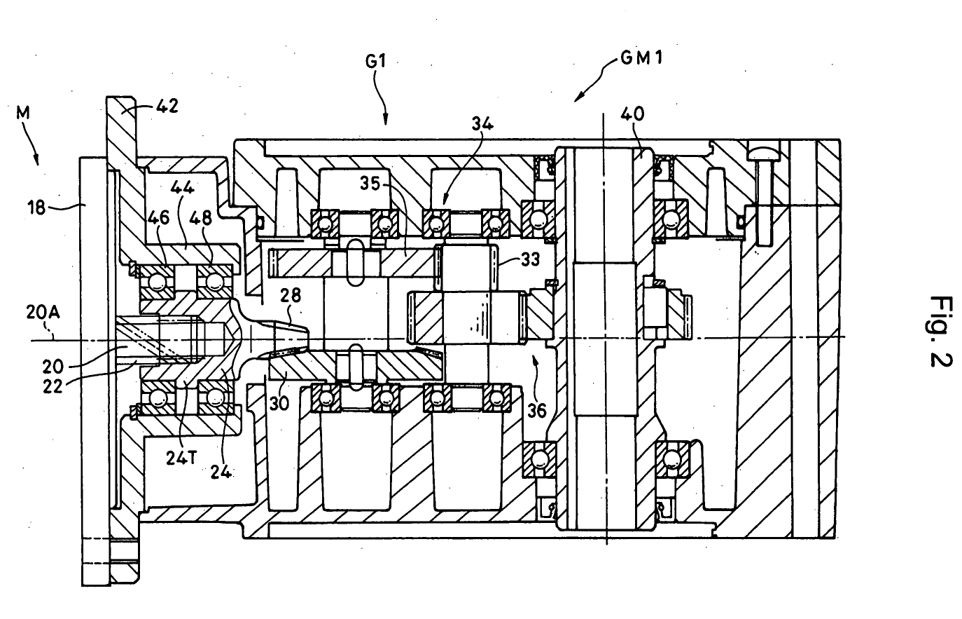

FIGS. 1 and 2 are a cross-sectional front view and a developed cross-sectional plan view each illustrating a geared motor according to an exemplary embodiment of the present invention.

A motor M (illustrated only with a front cover 18) of this geared motor GM1 is integrally provided, at an end of its motor shaft 20, with a helical pinion 22.

The helical pinion 22 is engaged with a coupling shaft (shaft member) 24. That is, there is formed a female helical portion (engagement portion) 26 on one end of the coupling shaft 24. The female helical portion 26 is screwed over the outer circumference of the helical pinion 22 (helical-spline couple), thereby allowing both the pinion 22 and the shaft 24 to rotate integrally (at the same speed). A hypoid pinion 28 is integrally formed on the other end of the coupling shaft 24. The hypoid pinion 28 engages with a hypoid gear 30, and forms a hypoid reduction mechanism 32 corresponding to the first stage of a reduction portion G1 in conjunction with the hypoid gear 30.

At the subsequent stage of the hypoid reduction mechanism 32, there are disposed first and second parallel axis gear reduction mechanisms 34 and 36, so that output is finally delivered from an output shaft 40.

Note that although FIG. 1 depicts the hypoid gear 30 and a pinion 33 as if they engage with each other, a spur (or helical) gear 35 having almost the same diameter as that of the hypoid gear 30 engages with the pinion 33, thereby forming the first parallel axis gear reduction mechanism 34 for purposes of increasing speed.

The motor shaft 20 and the output shaft 40 are orthogonal to each other, and the geared motor GM1 forms an “orthogonal geared motor.” Note that an axial center 20A of the motor shaft 20 and an axial center 40A of the output shaft 40 do not intersect each other on the same plane; however, as used herein, the term “orthogonal” also includes such an intersection.

There is formed a cylindrical portion 44 in a coupling cover 42 of the reduction portion G1. There are disposed a pair of bearings 46 and 48 inside the cylindrical portion 44, so that the pair of bearings 46 and 48 rotatably support the coupling shaft 24. At an end portion of the cylindrical portion 44, there is formed a projected portion 50 for restricting the axial movement of the bearing 48 (in the direction to the right in the figure). On the coupling shaft 24, an annular stepped portion (projected portion) 24T is formed on the periphery thereof (along entire circumference) generally at its axial center in order to define the axial position thereof with respect to the bearings 46 and 48. Note that instead of the annular stepped portion 24T formed along entire circumference, a mere projection (projected portion) may also be integrally formed on the coupling shaft. Alternatively, a hole may be formed in the coupling shaft 24 to insert a pin into the hole, thereby forming a projected portion. A retaining ring 52 is disposed on the motor M side of the cylindrical portion 44 to restrict the axial movement of the bearing 46 (in the direction to the left in the figure). The reference symbol 54 indicates a shim for adjusting the positions of the three components (the bearing 46, the coupling shaft 24, and the bearing 48) with respect to the coupling cover 42.

The direction of thrust force produced on the coupling shaft 24 by coupling the helical pinion 22 to the female helical portion (engagement portion) 26 of the coupling shaft 24 and the direction of thrust force produced on the coupling shaft 24 by the hypoid pinion 28 of the coupling shaft 24 engaging with the hypoid gear 30 can be aligned with each other in the same direction or in an opposite direction. This can be realized by appropriately choosing or designing the directions of tooth cutting of the helical pinion 22 of the motor shaft 20 and the hypoid pinion 28. Note that in the illustrated example, the teeth are cut in such a direction as to align the thrust forces in the same direction. The specific operation of each of these arrangements regarding the handling of the thrust forces will be described later in more detail.

Now, the operation of the geared motor GM1 according to this exemplary embodiment will be explained.

When the helical pinion 22 of the motor shaft 20 rotates in a specific direction, the coupling shaft 24 rotates integrally (at the same speed) via the female helical portion 26 that is helical-spline coupled to the helical pinion 22. As a result, the hypoid pinion 28 formed on the other end of the coupling shaft 24 rotates, and the hypoid gear 30 that engages with the hypoid pinion 28 also rotates. The rotation of the hypoid gear 30 is increased and transmitted to the pinion 33 from the spur gear 35 (of the first parallel axis gear reduction mechanism 34) formed on the same rotational shaft 31. The rotation of the hypoid gear 30 is then reduced again via the second parallel axis gear reduction mechanism 36 to be delivered from the output shaft 40. Note that the rotation is once increased on the way of the power transmission path in order to realize various reduction ratios (from a low reduction ratio to a high reduction ratio) with the same number of stages. Inserting a speed-increasing stage makes it possible to realize a low reduction ratio (e.g., a total reduction ratio of 5).

The axial center 40A of the output shaft 40 is orthogonal to the axial center 20A of the motor shaft 20 (in a broad sense), so that the rotation of the motor shaft 20 is delivered from the output shaft 40 with the axial center 20A being rotated by 90 degrees.

Now, the operation regarding the selection of the thrust direction will be described in detail.

As described above, in this exemplary embodiment, the direction of tooth cutting for the helical pinion 22 of the motor shaft 20 and the direction of tooth cutting for the hypoid pinion 28 can be appropriately chosen. Such an arrangement allows the direction of thrust force produced on the coupling shaft 24 by coupling the helical pinion 22 of the motor shaft 20 to the female helical portion (engagement portion) 26 of the coupling shaft 24 and the direction of thrust force produced on the coupling shaft 24 by the hypoid pinion 28 of the coupling shaft 24 engaging with the hypoid gear 30 to be aligned with each other in the same direction or in an opposite direction.

Each arrangement has its own advantage, and thus may be appropriately chosen or designed according to applications or purposes of service.

With the directions of the thrust forces aligned in the same direction, suppose that the motor shaft 20 of the motor M rotates in a particular (or specific) direction. In this case, the coupling shaft 24 is subjected to a thrust force from the motor shaft 20 side in a particular direction (e.g., in the direction of arrow A) and as well subjected to a thrust force from the hypoid gear 30 side so as to be pulled towards the hypoid side (in the same direction as arrow A). Accordingly, as a result, the motor shaft 20 rotating in a particular direction causes the coupling shaft 24 to be subjected to a slightly strong thrust force only in a particular direction (in the direction of arrow A). Note that the motor shaft 20 rotating in the opposite direction would cause a slightly strong thrust force to be produced in a direction opposite to arrow A (in this case, in the direction of arrow B).

This results in the coupling shaft 24 rotating so as to move in either direction all the time while being subjected to a slightly strong thrust force. Thus, even under light-load conditions, no tooth striking noises occur which would be otherwise caused by variations in torque, and thus a higher degree of silencing can be achieved.

When the coupling shaft 24 is subjected to thrust force in either direction, the thrust forces which are imparted to the coupling shaft 24 can be positively received and fixed in the direction of arrow A via the stepped portion 24T of the coupling shaft 24, the bearing 48, and the projected portion 50, and in the direction of arrow B via the stepped portion 24T of the coupling shaft 24, the bearing 46, and the retaining ring 52, respectively. For this reason, a bearing (not shown) which retains the motor shaft 20 or the rotational shaft 31 supporting the hypoid gear 30 has to be responsible only for reactive engaging force that is originally produced on its own side. Thus, on both the motor shaft 20 side and the hypoid gear 30 side, an existing (or standard) motor or a gearbox can be used as it is without any particular changes made to the design.

On the other hand, when the direction of thrust force produced is oppositely defined, for example, when the motor shaft 20 rotates in a particular direction, the coupling shaft 24 is subjected to thrust force from the motor shaft 20 side in a particular direction (e.g., in the direction of arrow A), and subjected to thrust force from the hypoid gear 30 side in the opposite direction (in this case, in the direction of arrow B). Accordingly, the thrust forces are opposed to each other and thus cancelled out within the coupling shaft 24, and the resulting thrust force on the coupling shaft 24 is less than the thrust force exerted only from the hypoid gear 30 side or the motor shaft 20 side. When the motor shaft 20 rotates in the opposite direction, the thrust forces repel each other. That is, the thrust forces are thus cancelled out within the coupling shaft 24. The resulting thrust force on the coupling shaft 24 is also less than the thrust force exerted only from the hypoid gear 30 side or the motor shaft 20 side. Accordingly, since the thrust load on the bearings 46 and 48 supporting the coupling shaft 24 is drastically reduced, the bearings 46 and 48 can be reduced in size and in costs, and increased in service life.

Additionally, in this case (when the direction of each thrust force is defined oppositely), the bearing, which retains the motor shaft 20 or the rotational shaft 31 supporting the hypoid gear 30, has to be responsible only for reactive engaging force that is originally produced on its own side. Thus, on both the motor shaft 20 side and the hypoid gear 30 side, an existing (or standard) motor or a gearbox can be used as it is without any particular changes made to the design.

In this exemplary embodiment, the coupling shaft 24 is supported by the pair of bearings 46 and 48 sandwiching the annular stepped portion 24T disposed at the center in its axial direction, and is positioned in both axial directions via the pair of bearings 46 and 48. Accordingly, this arrangement makes it possible to achieve rotatable smooth support of the coupling shaft 24 and arbitrary handling of the thrust force in a reasonable manner.

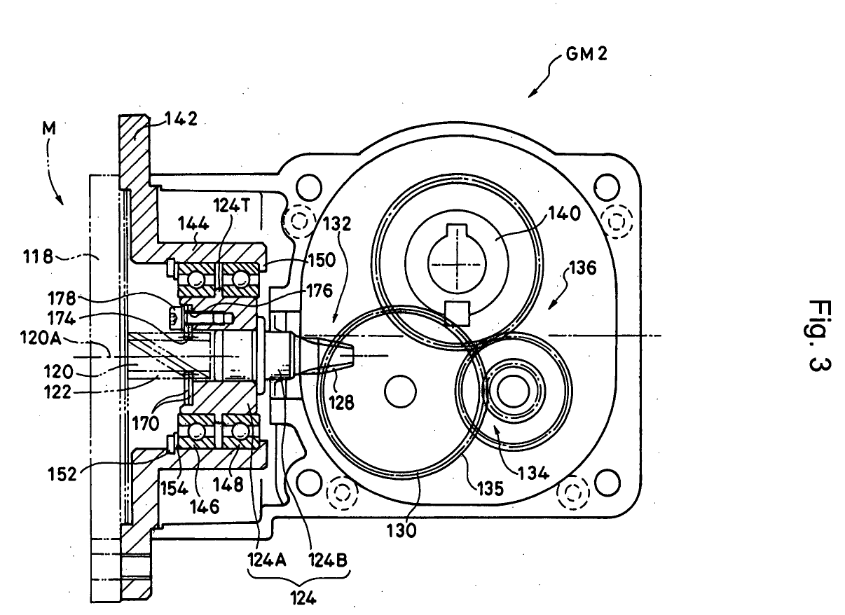

FIGS. 3 to 5 show another exemplary embodiment of the present invention.

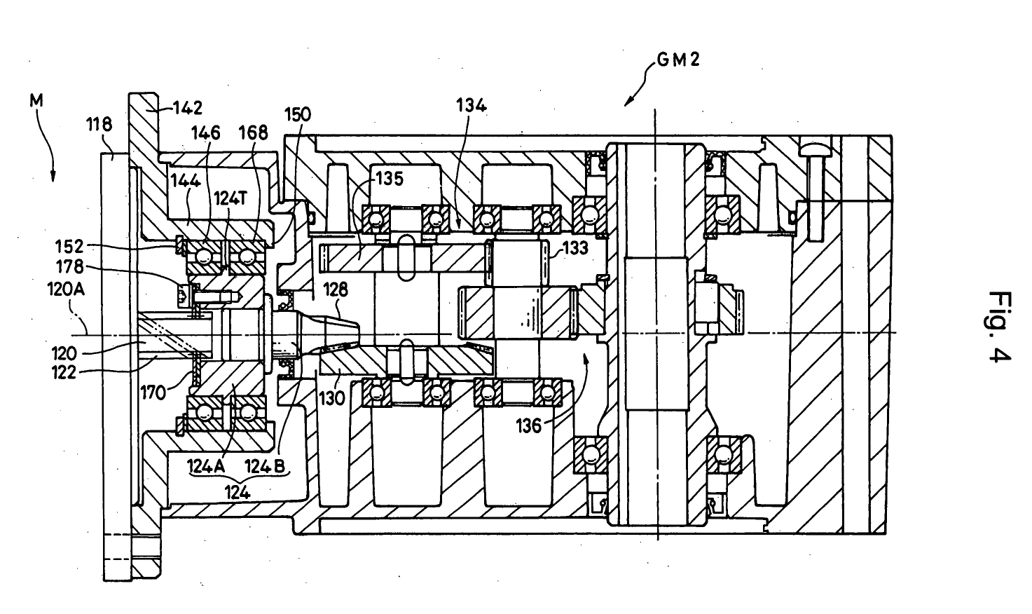

As shown in FIGS. 3 and 4, a geared motor GM2 according to this exemplary embodiment is adapted such that a helical pinion 122 and a coupling shaft 124 are engaged not by the female helical portion (26) being engaged almost entirely with the helical pinion 122 in the axial direction thereof but via only two plates 170. The coupling shaft 124 has two members 124A and 124B integrally press-fitted therein in this embodiment.

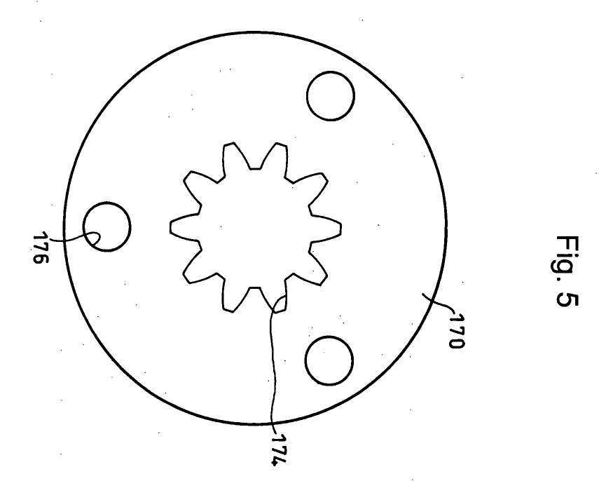

As shown in FIG. 5, each of the plates 170 has internal teeth 174, which is capable of engaging with the teeth of the helical pinion 122. Each of the plates 170 is superimposed on the other to be fixed to an end of the coupling shaft 124 via a bolt 178. Although not illustrated, the circumferential phases of the internal teeth 174 in each of the plates 170 are slightly shifted from each other in order to match the teeth of the helical pinion 122.

The configuration according to this embodiment corresponds to a configuration in which only two potions of the female helical portion 26 in the aforementioned embodiment is sliced and cut off in the axial direction. The plates 170 can be used singly, or alternatively three, four, or more plates 170 can be superimposed on another with their phases slightly shifted from each other, thereby providing a similar power transmission function. A plurality of plates may be employed to make allowance for transmission capacity. In the case of employing a plurality of plates, “spacing” may be allowed to exist between each of the plates 170 so long as the phase along the teeth of the helical pinion 122 is appropriately controlled. The phase can be controlled, for example, by adjusting the relative circumferential position of a bolt hole 176 with respect to the internal teeth 174 of each of the plates 170. Alternatively, a dedicated pin hole may also be formed with higher precision. The arrangement according to this embodiment is effective particularly in applications which require a reduction in costs and in size in the axial direction.

Other configurations and operations are basically the same as those of the aforementioned exemplary embodiment, and the same or like portions will not be repeatedly explained but merely indicated in the figures with those reference numerals that have the same two lowest digits.

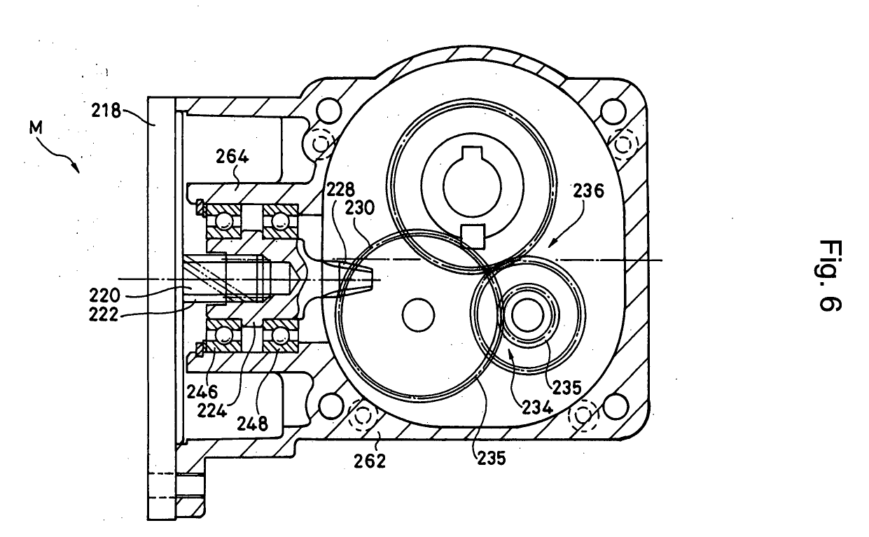

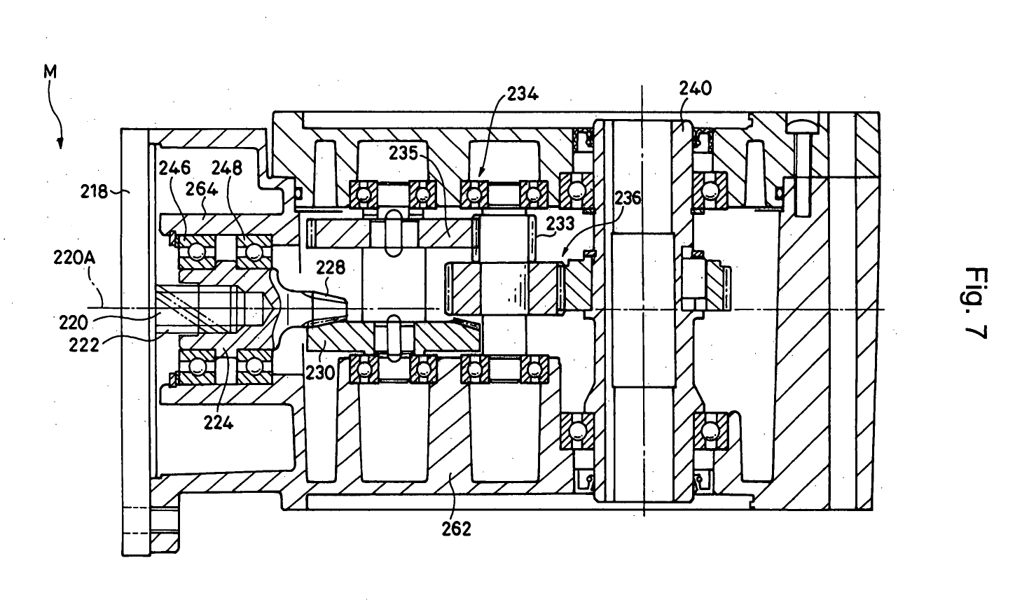

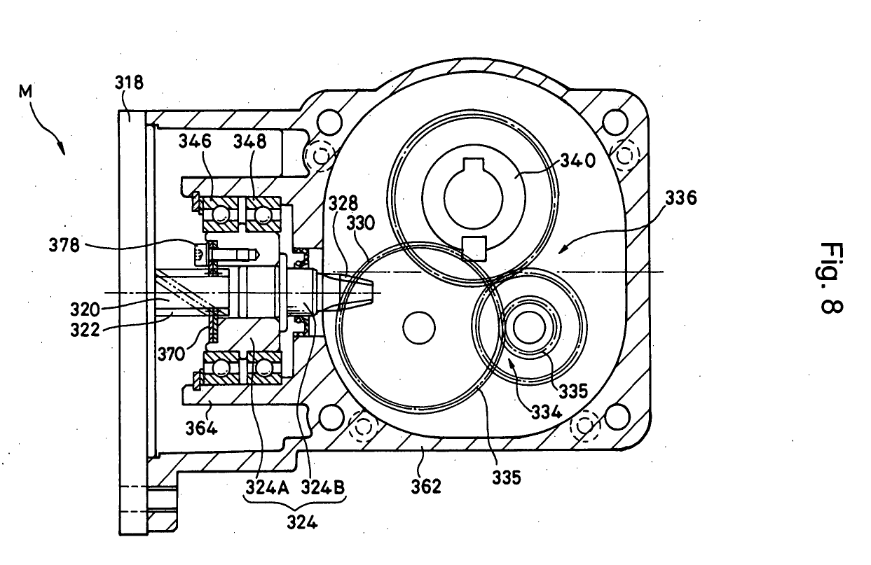

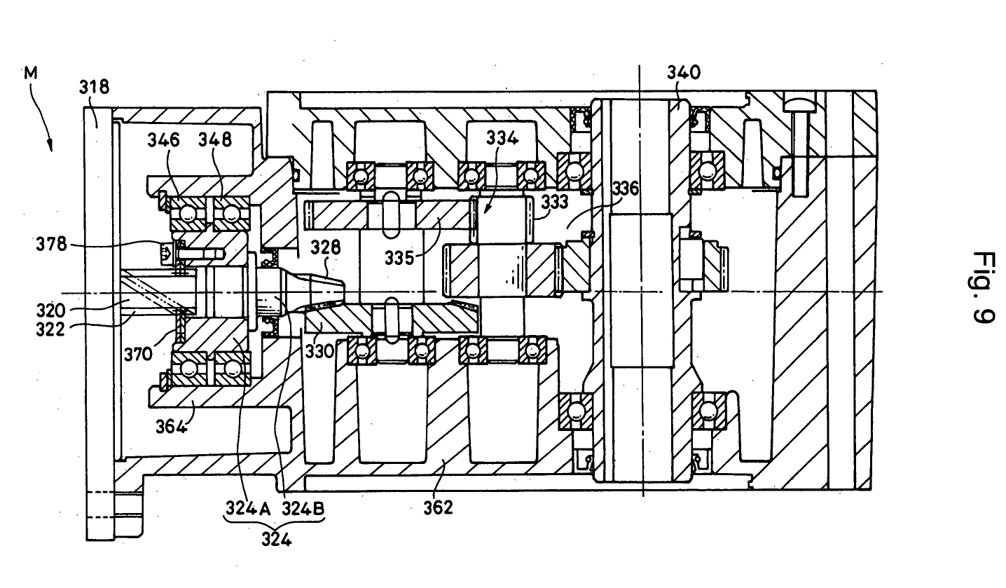

In either the aforementioned example shown in FIG. 1 and FIG. 2 or the example shown in FIGS. 3 to 5, the coupling cover 42 or 142 is prepared for accommodating the coupling shaft 24 or 124 so that the gearbox on the hypoid gear side can be used as it is. In this manner, the hypoid pinion and the bearing retaining the pinion are supported by a coupling cover that is separated from both the motor and the hypoid gearbox. With this arrangement, only inexpensive bearings and coupling covers have to be replaced in order to cope with changes in thrust force and torque. In contrast to this, how much thrust force will be produced may be known in advance. In this case, for example, as shown in either FIG. 6 and FIG. 7 or FIG. 8 and FIG. 9, a cylindrical portion 264 or 364 is integrally formed in a gearbox 262 or 362 on a hypoid gear 230 or 330 side, so that a coupling shaft 224 or 324 (324A or 324B) is supported in the cylindrical portion 264 or 364, respectively. Note that other configurations are the same as those of the aforementioned exemplary embodiment, and thus the same or like portions will not be repeatedly explained but merely indicated in the figures with those reference numerals that have the same two lowest digits.

The present invention is applicable in various scenes.

For example, to make use of the existing motor portion with a pinion as disclosed in Japanese Patent Laid-Open Publication No. 2001-74110 mentioned above, the rotation of the motor may be received once by the gear (intermediate stage) engaging with the pinion formed on the motor shaft and the power may be then transmitted to the originally intended hypoid pinion. In this case, however, this arrangement will not allow the hypoid gear set to be used at the “first stage,” thus possibly causing an increase in size of the hypoid gear set and an increase in costs. When the intermediate stage is used as an idle stage with no reduction, the involvement of the intermediate stage would totally cause an increase in costs and worsen the space efficiency.

In this respect, the present invention allows the existing motor with a helical pinion to be used as it is as well as the hypoid gear set to be used at “the first stage” only via one coupling shaft, thereby providing a great merit in this application scene.

Another application scene of the present invention may be a positive “diversified use” of the motor with a helical pinion as an orthogonal motor. For example, some makers of geared motors or large factories often have a large quantity of ordinary motors with a helical pinion in stock. In such a circumstance, applying the present invention allows the hypoid geared motor to be realized only through procurement of other than motors. As a result, costs may be drastically reduced when compared with the procurement of a totally new hypoid geared motor including the motor.

However, the industrial applicability of the present invention is not limited to these application scenes but the invention can also be utilized effectively in any scenes where a motor with a helical pinion is more widely used as the motor of a hypoid geared motor.

The disclosure of Japanese Patent Application No. 2005-176296 filed Jun. 16, 2005 including specification, drawing and claim are incorporated herein by reference in its entirety.

What is claimed is:

1. A geared motor comprising:
a motor having a helical pinion formed on a motor shaft;
a shaft member having an engagement portion at one end and a hypoid pinion formed at the other end, the engagement portion engaging with the helical pinion and integrally rotatable with the helical pinion; and
a hypoid gear to engage with the hypoid pinion, wherein
a direction of thrust force produced on the shaft member by the helical pinion engaging with the engagement portion matches with a direction of thrust force produced on the shaft member by the hypoid pinion engaging with the hypoid gear.

2. A geared motor comprising:
a motor having a helical pinion formed on a motor shaft;
a shaft member having an engagement portion at one end and a hypoid pinion formed at the other end, the engagement portion engaging with the helical pinion and integrally rotatable with the helical pinion; and
a hypoid gear to engage with the hypoid pinion, wherein
a direction of thrust force produced on the shaft member by the helical pinion engaging with the engagement portion and a direction of thrust force produced on the shaft member by the hypoid pinion engaging with the hypoid gear are opposite to each other.

3. A geared motor comprising:
a motor having a helical pinion formed on a motor shaft;
a shaft member having an engagement portion at one end and a hypoid pinion formed at the other end, the engagement portion engaging with the helical pinion and integrally rotatable with the helical pinion; and
a hypoid gear to engage with the hypoid pinion, wherein
the shaft member is supported by a pair of bearings, and is positioned in both axial directions via the pair of bearings.

4. A geared motor comprising:
a motor having a helical pinion formed on a motor shaft;
a shaft member having an engagement portion at one end and a hypoid pinion formed at the other end, the engagement portion engaging with the helical pinion and integrally rotatable with the helical pinion; and
a hypoid gear to engage with the hypoid pinion, wherein
the shaft member has a projected portion on a periphery thereof, and is positioned in either axial direction via the projected portion.

5. The geared motor according to any one of claims 1 to 4, wherein
the engagement portion of the shaft member has a plate which has internal teeth capable of engaging with teeth of the helical pinion and is fixed to the one end of the shaft member.

6. The geared motor according to claim 5, wherein
a plurality of the plates is provided side by side in the axial direction of the shaft member with the internal teeth being respectively in phase with the teeth of the helical pinion.

7. A shaft member for a geared motor, the shaft member being used in the geared motor to transmit rotation of a motor shaft towards a reduction portion, the motor shaft having a helical pinion,
the shaft member comprising:
an engaging portion at one end, the engaging portion engaging with the helical pinion to be integrally rotatable therewith;
a hypoid pinion formed at the other end, the hypoid pinion being capable of engaging with a hypoid gear to form a reduction mechanism of the reduction portion in conjunction with the hypoid gear; and
a projected portion on a periphery thereof.
